(19) United States
(12) Patent Application Publication
(10) Pub. No.: US 2016/0280246 A1
(43) Pub. Date: Sep. 29, 2016

(54) Hand Dolly with Electric Scissor Lift

(71) Applicant: ALEXIS PINO, Sarasota, FL (US)

(72) Inventor: ALEXIS PINO, Sarasota, FL (US)

(21) Appl. No.: 14/670,376

(22) Filed: Mar. 26, 2015

(51) Int. Cl. B62B 5/00; B62B 1/10; B62B 1/18

(52) U.S. Cl. CPC B62B 5/00; B62B 1/18; B62B 1/10

(57) ABSTRACT

A hand dolly with electric scissor lift assembly provides a dual purpose assembly comprising a hand dolly for loading and transporting a load, and an electric scissor lift for raising and lowering the load. The assembly includes a frame defined by a handle end, a base end, an upper rail, a lower rail, and a cavity. A platform engages the upper rail in a generally coplanar disposition. A flange extends perpendicular from the frame and the platform to enable loading and unloading on the platform. The wheels balance and transport the load. A scissor mechanism in the cavity of the frame includes upper and lower sets of supports arranged in a linked X configuration. An actuator applies a force on the lower supports to expand them, which in turn, expands the upper supports. This ultimately results in raising the platform. Conversely, the force is released to lower the platform.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a hand dolly with electrical scissor lift assembly that provides a both a hand dolly for loading and transporting a load, and an electric scissor lift for raising and lowering the load.

The inventor had moved loads before. The loads were often heavy and bulky. The inventor was aware that certain assemblies were used to help load, unload, transport, raise, and lower the loads. This was necessary because it was often necessary to manipulate heavy and bulky loads in places, such as warehouses, factories, farms, moving vans, and movie studios.

The inventor recognized a problem in that often, the loads had to be transported both horizontally on a ground surface, and also to vertically raise and lower the load to a desired elevation. However, the inventor could not find an assembly that performed both horizontal and vertical loading and transport functions.

At first, the inventor recognized that forklift devices permitted the lifting of crates, containers and various packaged materials and also moved them from location to location throughout a plant, warehouse or facility. However, the inventor quickly saw that this solution created additional concerns. For example, forklifts must be able to effectively move throughout a system, meaning that appropriate spacing and clearance must be available for the forklifts to reach all areas where materials must be introduced or removed from the system. Furthermore, forklifts pose additional costs, such as fuel and maintenance.

Through observation, the inventor discovered that the dolly was also effective for loading and transporting heavy, bulky loads. The inventor noted that the dolly generally includes a base having a lower portion supported by roller devices, such as wheels, a support surface mounted to the base on which a container is to be placed, a control frame mounted above the base and support surface which pivots, facilitating the loading and unloading of the container, and a locking mechanism having at least one locking position to hold the control frame in a stop position.

Through additional research, the inventor also learned that a scissor lift could be used to raise and lower the loads in a small space. The scissor lift was especially effective for facilitating the stacking or unstacking of loads on pallets or other supports. The inventor learned that the typical scissor lift incorporates a support platform and a mechanism for selectively raising or lowering the support platform into a position facilitating its loading or unloading. Through additional studies, the inventor learned that vertical movement of the support platform usually is accomplished via a scissor arm mechanism that supports the support platform on an underlying base and that is raised and lowered by way of one or more hydraulic or pneumatic cylinders.

The inventor wondered if the dolly and the scissor lift could be combined, so as to maximize the best features of each. The inventor initially built an elongated metal frame with an empty cavity. The inventor then added wheels on one end, and a handle on the opposite end of the frame. The inventor next added a platform and a flange that extended from the wheeled end of the platform. This resulted in a lever machine with the wheels serving as the fulcrum. The inventor concluded that a dolly with a large frame was constructed. This assembly could load and transport loads across a ground surface. However, vertical displacement of the load, especially to higher elevations was still not possible.

The inventor next decided to position a scissor mechanism inside the frame, such that the platform used to support the load in the dolly configuration could also be sued as a horizontal support platform in the scissor lift. At first, the inventor used a manual scissor mechanism. However, the inventor eventually used an electric motor. The finished product operated substantially as both a dolly and a scissor lift.

For the foregoing reasons, there is a hand dolly with electric scissor lift assembly that provides a dual purpose supportive assembly operating as both a hand dolly for loading and transporting a load; and an electric scissor lift for raising and lowering the load.

Assemblies for loading, unloading, transporting, raising, and lowering loads have been utilized in the past; yet none with the present dual purpose characteristics of the present invention. See U.S. Pat. Nos. 4,503,983; 5,722,513; and 6,176,670.

For the foregoing reasons, there is an assembly that is configured to provide the functionality of a hand dolly for loading and transporting a load; and an electric scissor lift for raising and lowering the load.

### SUMMARY

The present invention describes a hand dolly with electric scissor lift assembly that provides a dual purpose assembly that functions as both a hand dolly for loading and transporting a load; and an electric scissor lift for raising and lowering the load. The hand dolly with electric scissor lift assembly is configured to switch functionalities between a standard hand dolly that operates as a first class lever and fulcrum for wedging, lifting, and transporting the load in a generally horizontal disposition; and an electric scissor lift for displacing the load in a generally vertical disposition through the use of a scissor mechanism. Consequently, a synergy is created between the dolly and the scissor lift that optimizes loading, transport, vertical displacement, and general manipulation of the load.

In some embodiments, the assembly may include a generally rectangular frame. The frame provides the direct support for the load in the dolly configuration. The frame also forms a supportive enclosure for operation of the scissor lift. The frame is defined by a handle end, a base end, at least one upper rail, at least one lower rail, and a cavity. In some embodiments, the assembly further comprises a platform. The platform is configured to overlay the at least one upper rail in a generally coplanar disposition. The platform provides the greater surface area for the load to rest on in both the dolly and scissor lift configurations.

A flange extends generally perpendicular from the base end of the frame. The flange also extends past the plane of the platform, wherein the flange and the platform form a junction. However, in one alternative embodiment, the flange extends directly from the base end of the platform. The flange is effective for wedging under the load for lifting, and also restricting the load from falling of the platform.

At least one wheel is disposed at the base end of the frame. In one embodiment, the at least one wheel is a pair of spaced-apart wheels on the lateral sides of the frame. The wheel is used to pivotally balance and transporting the load. A handle is disposed at the handle end of the frame. In some embodiments, the frame is configured to pivotally balance on the at least one wheel between an upright position and a horizontal position. In the horizontal position, the handle end rests on the handle and the base end rests on the at least one wheel. In the upright position, the flange provides a base of support for the assembly. The assembly may be tilted back for loading and transport, with the wheel serving as a fulcrum.

In operation of the dolly, the flange is utilized to set the load on, flat against the floor when the frame is upright, standing on the base end. During loading and unloading, the load is tilted forward, the flange is wedged underneath, and the load allowed to tilt back and rest on the junction between the flange and the platform. Then the frame and the load are tilted backward until the weight is balanced over the at least one wheel. In this loaded position, the frame and the load are rolled to the desired location. Those skilled in the art will recognize that the dolly configuration makes otherwise bulky and heavy loads easier to move.

In some embodiments, a scissor mechanism is used to raise and lower the platform generally perpendicular to the frame. The scissor mechanism is disposed, at least partially, in the cavity of the frame. The scissor mechanism is defined by a lower set of supports and an upper set of supports. The lower set of supports are in communication with the upper set of supports. In some embodiments, a support beam extends between the lower set of the supports. The support beam expands and retracts the lower set of supports. An actuator is configured to apply a force on the support beam. A jack pivotally anchors to the lower set of supports. The jack moves in and out of the actuator to apply the force directly on the support beam.

In some embodiments, the actuator applies the force on the support beam to expand the lower set of supports, wherein expansion of the lower set of supports imparts an expansion on the upper set of supports, wherein expansion of the upper set of supports raises the platform. In some embodiments, the actuator releases the force on the support beam to retract the lower set of supports, wherein retraction of the lower set of supports imparts a retraction on the upper set of supports, wherein retraction of the upper set of supports lowers the platform.

One objective of the present invention is to provide a dual purpose supportive assembly operating as both a hand dolly for loading and horizontally transporting a load; and an electric scissor lift for vertically raising and lowering the load.

Another objective is to provide a means for loading a load onto a platform of a dolly while also vertically raising the load from the ground.

Another objective of the present invention is to provide a loading and transporting means which is integrally incorporated into the construction of the dolly.

Yet another objective is to provide a lifting means that relies directly on the scissor movement between two structural supports coupled to one another in a pivoting relationship.

Yet another objective of the present invention is to provide a mobile lifting means for lifting heavy loads in the field.

Yet another objective is to provide a hand dolly with electric scissor lift assembly that is compact and simple in construction and operation.

### DRAWINGS

These and other features, aspects, and advantages of the present invention will become better understood with regard to the following description, appended claims, and drawings where:

FIGS. 1A and 1B are perspective views of an exemplary hand dolly with electric scissor lift assembly in an exemplary dolly configuration;

FIGS. 2A and 2B are sectioned perspective views of the hand dolly with electric scissor lift assembly showing an exemplary scissor mechanism retracted to form the dolly configuration;

FIGS. 3A and 3B are perspective views of the hand dolly with electric scissor lift assembly in the scissor lift configuration;

FIG. 4 is an elevated side view of the hand dolly with electric scissor lift assembly in the scissor lift configuration;

FIG. 5 is a frontal view of the hand dolly with electric scissor lift assembly in the scissor lift configuration;

FIG. 6 is an elevated side view of the hand dolly with electric scissor lift assembly in the scissor lift configuration operating as a dolly; and

FIG. 7 is an elevated side view of the hand dolly with electric scissor lift assembly in the scissor lift configuration operating as a scissor lift.

### DESCRIPTION

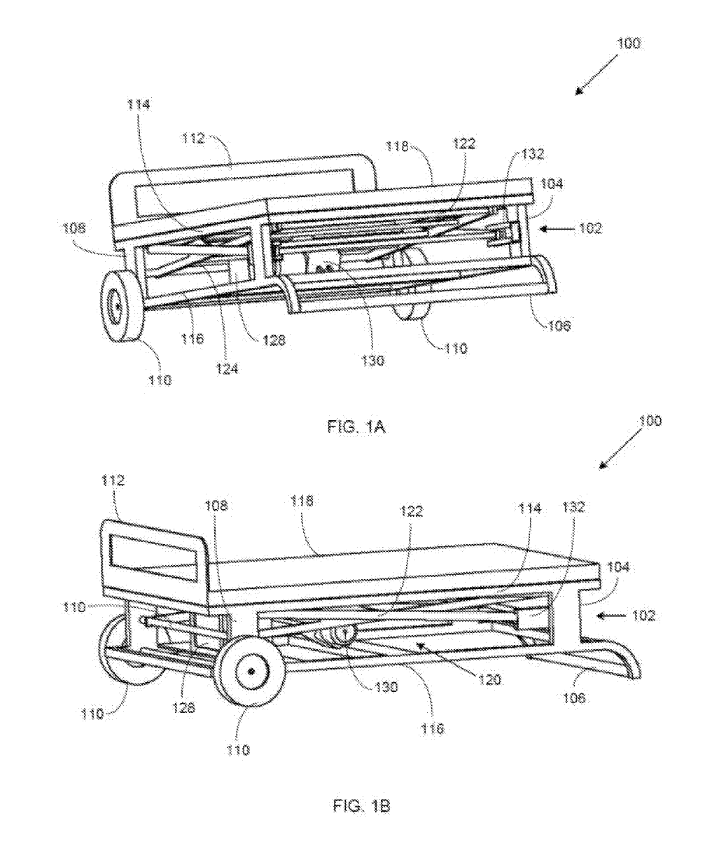

The present invention, referenced in FIGS. 1A-7, is directed to a hand dolly with electric scissor lift assembly 100, hereinafter “assembly”, that provides a dual purpose assembly 100 that operates as both a hand dolly for loading and transporting a load (not shown); and an electric scissor lift for raising and lowering the load. The assembly 100 is configured to switch functionalities between a standard hand dolly that operates as a first class lever and fulcrum for wedging, lifting, and transporting the load in a generally horizontal disposition; and an electric scissor lift for displacing the load through the use of a scissor mechanism 120 in a generally vertical disposition. A synergy is created between the dolly and the scissor lift that optimizes loading, transport, raised and lowered displacement, and general manipulation of the load.

As referenced in FIG. 1A, the assembly 100 may include a frame 102. The frame 102 provides direct support for the load in the dolly configuration. The frame 102 also forms a supportive enclosure for operation of the scissor mechanism 120. In one possible embodiment, the frame 102 is defined by a handle end 104, a base end 108, at least one upper rail 114, at least one lower rail 116, and a cavity. The frame 102 may form a substantially rectangular shape. However, in other embodiments, the frame 102 may form a square, triangular, or circular shape.

The assembly 100 further comprises a platform 118. The platform 118 provides the greater surface area for the load to rest on in both the dolly configuration and the scissor lift configuration. In one embodiment, the platform 118 is a generally flat, rigid support that overlays an upper region of the frame 102. The platform 118 is configured to engage the at least one upper rail 114 in a generally coplanar disposition.

As shown in FIG. 1B, a flange 112 extends generally perpendicular from the base end 108 of the frame 102. The flange 112 also extends past the plane of the platform 118, wherein the flange 112 and the platform 118 form a junction. However, in an alternative embodiment, the flange 112 extends directly from the platform 118, on the base end 108. The flange 112 is effective for wedging under the load for lifting, and also restricting the load from falling off the platform 118. In one embodiment, the flange include a metal panel having a central open space and rounded corners, as shown in FIG. 1A.

At least one wheel 110 is disposed at the base end 108 of the frame 102. In one embodiment, the at least one wheel 110 is a pair of spaced-apart wheels on each side of the base end 108 of the frame 102. The wheel 110 is configured to pivotally load/unload, balance, and transport the load. A handle 106 is disposed at the handle end 104 of the frame 102.

In some embodiments, the frame 102 is configured to pivotally balance on the at least one wheel 110 between an upright position and a horizontal position. In the horizontal position, the handle 106 rests on a ground surface, and the base end 108 rests on the at least one wheel 110 (FIG. 1B). In the upright position, the flange 112 provides a base of support for the assembly 100. Here, the assembly 100 may be tilted back for loading and transport, with the wheel 110 serving as a fulcrum (FIG. 1A).

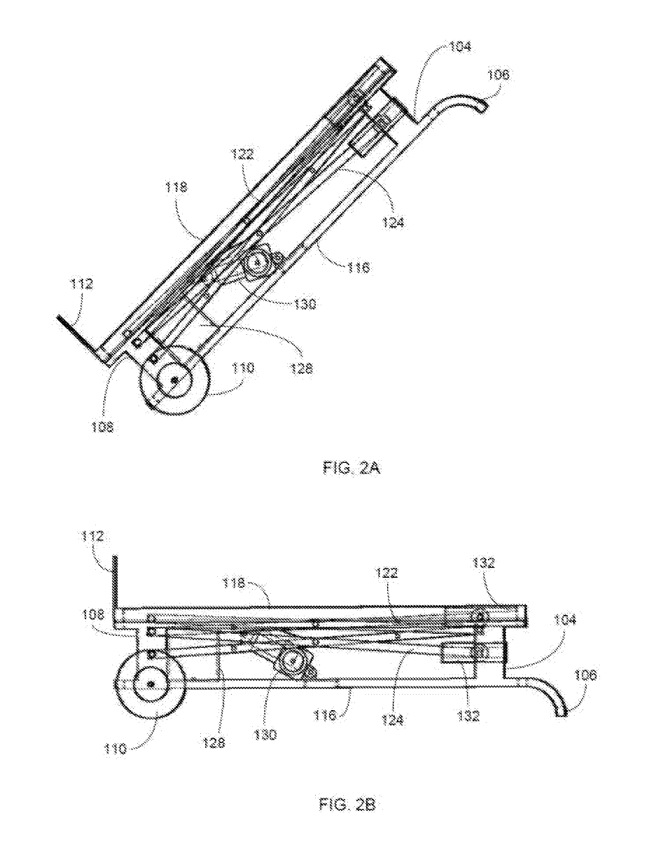

The dolly configuration is illustrated in FIGS. 2A and 2B, including the scissor mechanism 120 that raises and lowers the platform 118. In operation of the dolly, the flange 112 is utilized to set the load flat against the ground surface when the frame 102 is upright, standing on the base end 108. During loading and unloading, the load is tilted forward, the flange 112 is wedged underneath, and the load allowed to tilt back and rest on the junction between the flange 112 and the platform 118. Then the frame 102 and the load are tilted backward until the weight is balanced over the at least one wheel 110. In this loaded position, the frame 102 and the load are rolled to the desired location. Those skilled in the art will recognize that the dolly configuration makes otherwise bulky and heavy loads easier to move.

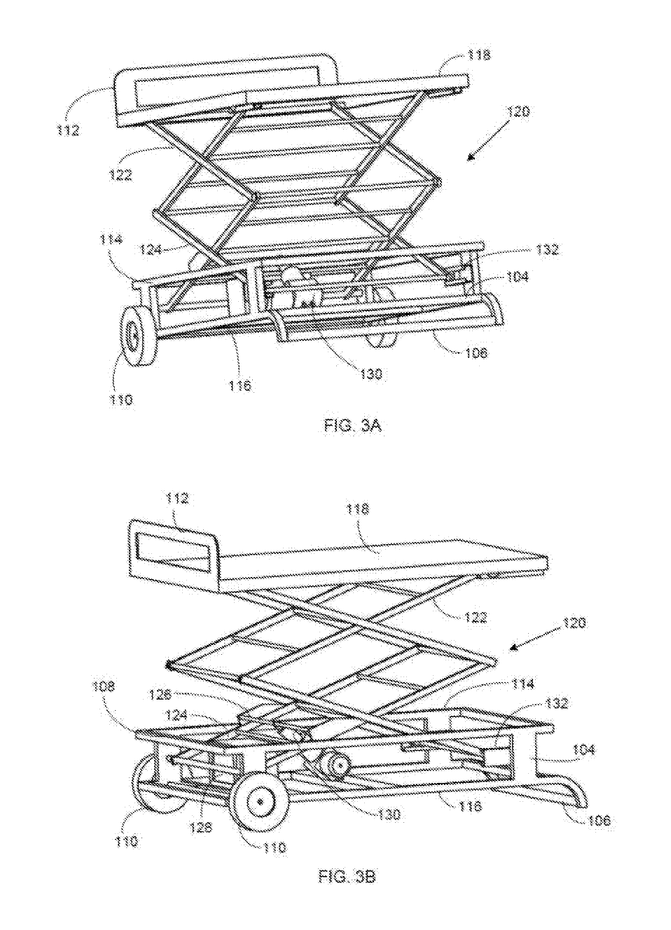

As shown in FIG. 3A, a scissor mechanism 120 is used to raise and lower the platform 118 generally perpendicular to the frame 102. The scissor mechanism 120 is disposed, at least partially, in the cavity of the frame 102. The scissor mechanism 120 is defined by a lower set of supports 124 and an upper set of supports 122 (FIG. 3B). The lower set of supports 124 are hingedly in communication with the upper set of supports 122, such that expansion or retraction of the lower set of supports 124 causes the same motion by the upper set of supports 122.

In some embodiments, a support beam 126 extends between the lower set of the supports 124. An actuator 128 is configured to apply a force on the support beam 126. A jack 130 pivotally anchors to the lower set of supports 124. The jack 130 moves in and out of the actuator 128 to apply the force directly on the support beam 126. The support beam 126 is configured to expand and retract the lower set of supports 124.

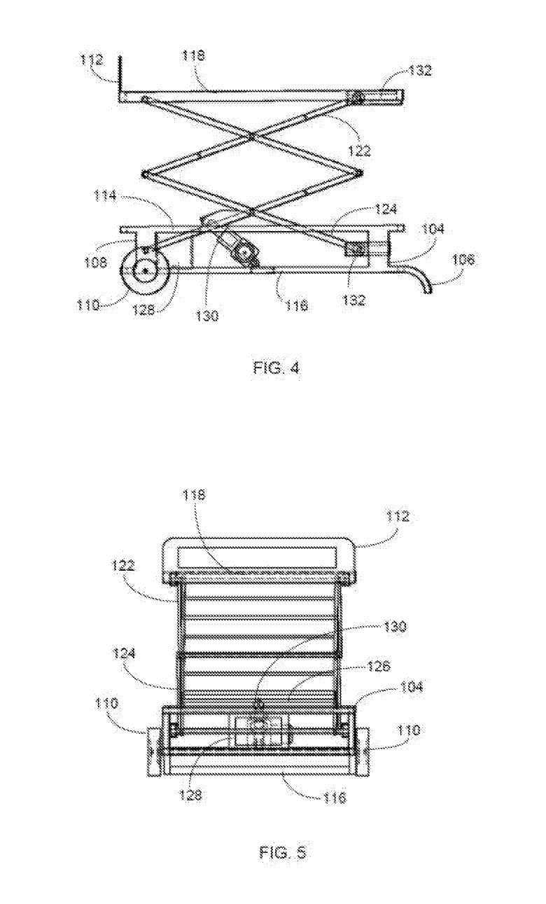

Turning now to FIG. 4, the actuator 128 applies the force on the support beam 126 to expand the lower set of supports 124, wherein expansion of the lower set of supports 124 imparts an expansion on the upper set of supports 122. As the upper set of supports 122 expands, the platform 118 raises. In some embodiments, the actuator 128 releases the force on the support beam 126 to retract the lower set of supports 124, wherein retraction of the lower set of supports 124 imparts a retraction on the upper set of supports 122. As the upper set of supports 122 retracts, the platform 118 lowers. In some embodiments, the handle end 104 of the frame 102 includes a support track 132 that receives the terminus of the lower and upper set of supports 122, 124 to provide enhanced stability during the expansion and refraction motions. The support track 132 may include a bracket with internal bearings that facilitates movement of the lower and upper set of supports 122, 124.

In some embodiments, the dolly configuration may be a first-class lever that forms a simple machine for pivotally loading and unloading the load, and then transporting the load across a ground surface. The dolly configuration includes a generally rectangular frame 102 defined by a handle end 104 having a handle 106, a base end 108 having at least one wheel 110, at least one upper rail 114, at least one lower rail 116, and a cavity. A supportive platform 118 rests on the upper rail 114 of the frame 102. The platform 118 may include a substantially rigid, plane that serves as the chief supporting structure for the load on the dolly.

To help retain the load on the platform 118, a small flange 112 extends perpendicularly from the base end 108 of the frame 102. The flange 112 extends past the platform 118, forming a restrictive barrier to prevent the load from falling off the platform 118 in both the inclined dolly configuration and the substantially flat scissor lift configuration. However, in one alternative embodiment, the flange 112 extends directly from the base end 108 of the platform 118.

In operation of the dolly, the flange 112 is utilized to set the load on, flat against the floor when the frame 102 is upright, standing on the base end 108. During loading and unloading, the load is tilted forward, the flange 112 is wedged underneath, and the load allowed to tilt back and rest on the junction between the flange 112 and the platform 118. Then the frame 102 and the load are tilted backward until the weight is balanced over the at least one wheel 110. In this loaded position, the frame 102 and the load are rolled to the desired location. Those skilled in the art will recognize that the dolly configuration makes otherwise bulky and heavy loads easier to move.

Referencing FIG. 5, the electric scissor lift may be configured to automatically raise and lower the platform 118 and the load. The platform 118 is displaced in a generally perpendicular direction relative to the position of the frame 102. The scissor mechanism 120 is disposed within the cavity of the frame 102. The scissor mechanism 120 operates by leveraging an applied force onto a series of hinges that connect the upper and lower sets of supports 122, 124.

As shown in FIG. 6, the scissor mechanism 120 includes linked, folding supports 122, 124 arranged in a crisscross X pattern. The supports 122, 124 are defined by an upper set of supports 122 and a lower set of supports 124 that are hingedly connected. In one embodiment, both the upper and lower supports 122, 124 are spaced-apart and parallel, so as to provide optimal balance of the assembly 100 in the scissor lift configuration.

The platform 118 rests on the at least one upper rail 114 and the upper set of supports 122. In one embodiment, the platform 118 remains generally coplanar with the length of the upper rail 114 while being raised and lowered, such that the load has a level surface of support. The platform 118 serves as the chief supporting structure for the load for both the scissor lift configuration and the aforementioned dolly configuration.

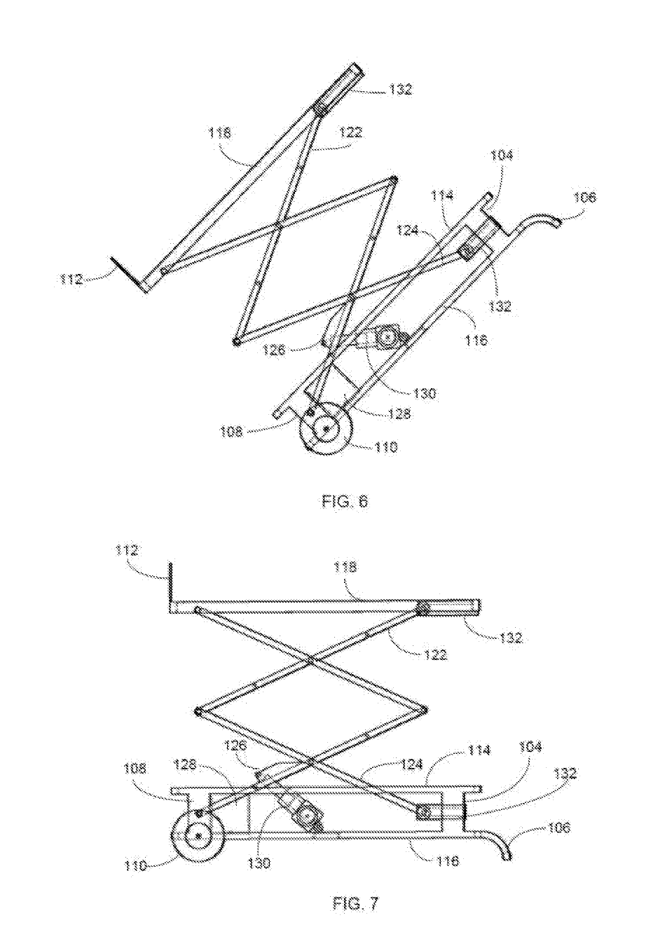

As illustrated in FIG. 7, a support beam 126 extends transversely between the lower set of supports 124, serving to extend and contract the lower sets of supports 124, and also serving to provide structural integrity to the scissor mechanism 120. The scissor mechanism 120 further includes an actuator 128 that generates a force transversely across the support beam 126. The actuator 128 may include, without limitation, an electrically operated hydraulic motor, pneumatic motor, corkscrew, and rack and pinion.

The actuator 128 operates a jack 130. The jack 130 may include a hydraulic or pneumatic jack. The jack 130 directly applies the force from the actuator 128 to the support beam 126. This causes the lower set of supports 124 to extend or contract, which in turn extends or retracts the upper set of supports 122, such that the platform 118 is displaced.

In one exemplary embodiment, the force that is applied to the support beam 126 elongates the crossing pattern, and raises the platform 118 and the load. From this position, the assembly 100 may be used in a dolly configuration (FIG. 6), or the scissor lift configuration (FIG. 7). In either case, the handle 106 is used to load and unload, transport, and position the load on the platform 118

Those skilled in the art, in light of the present teachings, will recognize that the jack 130 engages to a point slightly off center form the support beam 126. The off center engagement is important because it affects the amount of force needed to raise and lower the sets of supports 122, 124. It is significant to note that in this configuration, significantly more lateral force must be applied on the support beam 126 to raise the platform 118 the first few degrees, and less force would be required to raise the platform 118 after that.

Additionally, in the scissor lift configuration, the flange 112 extends from one end of the frame 102, serving as a barrier to prevent the load from falling off the platform 118, rather than a wedge for lifting the object, as in the dolly configuration. However, the flange 112 may also extend directly from the platform 118, as shown in the illustrations, to restrict the load from falling off the platform 118.

Those skilled in the art will recognize that the scissor lift configuration is easily maneuverable in tight spaces and may extend to high elevations. Additionally, the scissor lift configuration provides the advantage of over other lift mechanisms in that a lot of displacement is possible from a small space. Furthermore, the scissor lift configuration, when retracted, occupies a fraction of its height when extended.

While the inventor's above description contains many specificities, these should not be construed as limitations on the scope, but rather as an exemplification of several preferred embodiments thereof. Many other variations are possible. For example, the actuator 128 could be a hand operated electrical motor with a screw mechanism, or the actuator 128 could be a remotely operated electrical motor. Accordingly, the scope should be determined not by the embodiments illustrated, but by the appended claims and their legal equivalents.

What is claimed is:

1. A hand dolly with electrical scissor lift assembly for loading, unloading, transporting, raising, and lowering a load, the assembly comprising:
a frame, the frame defined by a handle end, a base end, at least one upper rail, at least one lower rail, and a cavity;
a platform, the platform configured to engage the at least one upper rail in a generally coplanar arrangement;
a flange, the flange extending generally perpendicular from the base end of the frame, and extending beyond a plane formed by the platform;
at least one wheel, the at least one wheel disposed at the base end of the frame;
a handle, the handle disposed at the handle end of the frame;
a scissor mechanism, the scissor mechanism defined by a lower set of supports and an upper set of supports, the lower set of supports being in communication with the upper set of supports, the scissor mechanism disposed, at least partially, in the cavity of the frame;
a support beam, the support beam extending between the lower set of the supports, the support beam configured to expand and retract the lower set of supports; and
an actuator, the actuator configured to apply a force on the support beam,
wherein the actuator applies the force on the support beam to expand the lower set of supports, wherein expansion of the lower set of supports imparts an expansion on the upper set of supports, wherein expansion of the upper set of supports raises the platform,
wherein the actuator releases the force on the support beam to retract the lower set of supports, wherein retraction of the lower set of supports imparts a retraction on the upper set of supports, wherein refraction of the upper set of supports lowers the platform.

2. The assembly of claim 1, wherein the assembly is configured for operation as a dolly and an electric scissor lift.

3. The assembly of claim 1, wherein the frame has a substantially rectangular shape.

4. The assembly of claim 1, wherein the platform is a substantially rigid plane.

5. The assembly of claim 1, wherein the platform positions on the at least one upper rail and the upper set of supports.

6. The assembly of claim 1, wherein the at least one upper rail is an upper pair of spaced-apart rails.

7. The assembly of claim 1, wherein the at least one lower rail is a lower pair of spaced-apart rails.

8. The assembly of claim 1, wherein the junction between the platform and the flange forms a support for the load.

9. The assembly of claim 1, wherein the upper and lower set of supports are linked, folding supports arranged in a crisscross X pattern.

10. The assembly of claim 1, wherein the actuator is an electrically operated hydraulic motor.

11. The assembly of claim 1, further including a jack.

12. The assembly of claim 11, wherein the jack is disposed between the actuator and the support beam, wherein the actuator is configured to operate the jack.

13. The assembly of claim 12, wherein the jack is configured to extend for directly applying the force from the actuator on the support beam.

14. The assembly of claim 1, wherein the scissor mechanism includes a support track configured to receives a terminus of the lower set of supports for providing guidance during the expansion and retraction motions.

15. A hand dolly with electrical scissor lift assembly for loading, unloading, transporting, raising, and lowering a load, the assembly comprising:
a frame, the frame defined by a handle end, a base end, at least one upper rail, at least one lower rail, and a cavity;
a platform, the platform configured to engage the at least one upper rail in a generally coplanar arrangement;
a flange, the flange extending generally perpendicular from the base end of the frame, and extending beyond a plane formed by the platform;
at least one wheel, the at least one wheel disposed at the base end of the frame;
a handle, the handle disposed at the handle end of the frame;
a scissor mechanism, the scissor mechanism defined by a lower set of supports and an upper set of supports, the lower set of supports being in communication with the upper set of supports, the scissor mechanism disposed, at least partially, in the cavity of the frame;
a support beam, the support beam extending between the lower set of the supports, the support beam configured to expand and retract the lower set of supports; and
an actuator, the actuator configured to apply a force on the support beam, wherein the actuator applies the force on the support beam to expand the lower set of supports,
wherein expansion of the lower set of supports imparts an expansion on the upper set of supports, wherein expansion of the upper set of supports raises the platform,
wherein the actuator releases the force on the support beam to retract the lower set of supports, wherein retraction of the lower set of supports imparts a retraction on the upper set of supports, wherein refraction of the upper set of supports lowers the platform.

16. The assembly of claim 15, wherein the frame has a substantially rectangular shape.

17. The assembly of claim 15, wherein the actuator is an electrically operated hydraulic motor.

18. The assembly of claim 15, further including a jack.

19. The assembly of claim 18, wherein the jack is disposed between the actuator and the support beam, wherein the actuator operates the jack for directly applying the force from the actuator on the support beam.

20. A hand dolly with electrical scissor lift assembly for loading, unloading, transporting, raising, and lowering a load, the assembly comprising:
a frame, the frame defined by a handle end, a base end, at least one upper rail, at least one lower rail, and a cavity;
a platform, the platform configured to engage the at least one upper rail in a generally coplanar arrangement;
a flange, the flange extending generally perpendicular from the base end of the frame, and extending beyond a plane formed by the platform;
at least one wheel, the at least one wheel disposed at the base end of the frame;
a handle, the handle disposed at the handle end of the frame;
a scissor mechanism, the scissor mechanism defined by a lower set of supports and an upper set of supports, the lower set of supports being in communication with the upper set of supports, the scissor mechanism disposed, at least partially, in the cavity of the frame;
a support beam, the support beam extending between the lower set of the supports, the support beam configured to expand and retract the lower set of supports;
an actuator, the actuator configured to apply a force on the support beam; and
a jack, the jack extending from the actuator for engaging the support beam with the force,
wherein the actuator applies the force on the support beam to expand the lower set of supports, wherein expansion of the lower set of supports imparts an expansion on the upper set of supports, wherein expansion of the upper set of supports raises the platform,
wherein the actuator releases the force on the support beam to retract the lower set of supports, wherein retraction of the lower set of supports imparts a retraction on the upper set of supports, wherein refraction of the upper set of supports lowers the platform.
